(19) United States
(12) Patent Application Publication
(10) Pub. No.: US 2018/0056735 A1
(43) Pub. Date: Mar. 1, 2018

(54) TIRE AIR PRESSURE MONITORING SYSTEM AND VEHICLE-MOUNTED RADIO DEVICE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Akinori Usami, Yokkaichi, Mie (JP)

(21) Appl. No.: 15/556,767

(22) PCT Filed: Mar. 11, 2016
(86) PCT No.: PCT/JP2016/057753

§ 371 Date: Sep. 8, 2017

(30) Foreign Application Priority Data
Mar. 13, 2015 (JP) 2015-051088

(51) Int. Cl. B60C 23/04; B60C 23/06

(52) U.S. Cl. CPC B60C 23/0466; G01L 17/00; B60C 23/061

(57) ABSTRACT

An tire air pressure monitoring system is provided configured to reduce the information amount of signals transmitted and received by a vehicle-mounted radio device and a vehicle-mounted communication device, and prevent a processing delay and a improve reliability of air pressure information. The tire air pressure monitoring system includes an air pressure acquisition unit that acquires the air pressure of a tire, a vehicle-mounted radio device wirelessly transmits a signal regarding the air pressure acquired by the air pressure acquisition unit, and a vehicle-mounted communication device in a separate location from the vehicle-mounted radio device and receives the signal transmitted by the vehicle-mounted radio device. The vehicle-mounted radio device includes a calculation unit calculating a temporal change amount of the air pressure acquired by the air pressure acquisition unit, and a transmission unit that transmits a signal indicating the air pressure change amount calculated by the calculation unit.

### CROSS-REFERENCE TO RELATED APPLICATIONS

This application is the U.S. national stage of PCT/JP2016/057753 filed Mar. 11, 2016, which claims priority of Japanese Patent Application No. JP 2015-051088 filed Mar. 13, 2015.

### TECHNICAL FIELD

The present invention relates to a tire air pressure monitoring system and a vehicle-mounted radio device.

### BACKGROUND

There is a tire air pressure monitoring system (TPMS: Tire Pressure Monitoring System) that detects the air pressure of a tire mounted to a vehicle and issues a warning or the like to a user if the detected air pressure is abnormal. The tire air pressure monitoring system includes a vehicle-mounted radio device that detects the air pressure of a tire and uses UHF-band radio waves to wirelessly transmit a signal that indicates the detected air pressure, a vehicle-mounted communication device that is provided on the vehicle body and receives the signal that was wirelessly transmitted by the vehicle-mounted radio device, and a reporting device that reports the air pressure indicated by the received signal.

In general, the higher the speed of a vehicle is, the higher the load on the tires is, and the higher the degree of risk is. Also, because the signal regarding tire air pressure is transmitted and received wirelessly, if the speed of the vehicle is high, there is an increased possibility that the vehicle-mounted communication device will fail to receive the signal regarding tire air pressure. JP 2006-69414A discloses a tire air pressure monitoring system in which the vehicle-mounted radio device is configured to transmit the signal regarding tire air pressure with a high degree of frequency.

However, if the signal regarding tire air pressure is transmitted and received with a high degree of frequency, there are problems such as that the information amount of the signals received and processed by the vehicle-mounted communication device increases, there is a possibility that a processing delay will occur, and the reliability of air pressure information decreases.

An object of the present invention is to provide a tire air pressure monitoring system and a vehicle-mounted radio device that enable reducing the information amount of signals transmitted and received by the vehicle-mounted radio device and a vehicle-mounted communication device, and enable preventing a processing delay and a decrease in the reliability of air pressure information.

### SUMMARY

A tire air pressure monitoring system according to an aspect of the present invention is a tire air pressure monitoring system that includes an air pressure acquisition unit that acquires an air pressure of a tire of a vehicle, a vehicle-mounted radio device that wirelessly transmits a signal regarding the air pressure acquired by the air pressure acquisition unit, and a vehicle-mounted communication device that is provided at a different location from the vehicle-mounted radio device and receives the signal transmitted by the vehicle-mounted radio device, the tire air pressure monitoring system monitoring air pressure based on the signal received by the vehicle-mounted communication device, wherein the vehicle-mounted radio device includes: a calculation unit that calculates a temporal change amount of the air pressure acquired by the air pressure acquisition unit; and a transmission unit that transmits a signal that indicates the air pressure change amount calculated by the calculation unit.

A vehicle-mounted radio device according to an aspect of the present invention is a vehicle-mounted radio device that includes an air pressure acquisition unit that acquires an air pressure of a tire of a vehicle, the vehicle-mounted radio device wirelessly transmitting a signal regarding the air pressure acquired by the air pressure acquisition unit, the vehicle-mounted radio device including: a calculation unit that calculates a temporal change amount of the air pressure acquired by the air pressure acquisition unit; and a transmission unit that transmits a signal that indicates the air pressure change amount calculated by the calculation unit.

Note that the invention of the present application can not only be realized as a tire air pressure monitoring system and a vehicle-mounted radio device that includes these characteristic processing units, but can also be realized as a tire air pressure monitoring method whose steps are these characteristic processes, or be realized as a program for causing a computer to execute these steps. Also, the invention can be realized as a semiconductor integrated circuit that realizes part of or the entirety of the tire air pressure monitoring system or vehicle-mounted radio device, or be realized as another system that includes the tire air pressure monitoring system or vehicle-mounted radio device.

### Advantageous Effects of Invention

According to the above configuration, it is possible to provide a tire air pressure monitoring system and a vehicle-mounted radio device that enable reducing the information amount of signals transmitted and received by the vehicle-mounted radio device and a vehicle-mounted communication device, and enable preventing a processing delay and a decrease in the reliability of air pressure information.

### BRIEF DESCRIPTION OF DRAWINGS

FIG. 1 is a schematic diagram showing one example of the configuration of a tire air pressure monitoring system according to a first embodiment of the present invention.

FIG. 2 is a block diagram showing one example of the configuration of a vehicle-mounted communication device.

FIG. 3 is a block diagram showing one example of the configuration of a vehicle-mounted radio device.

FIG. 4 is a flowchart showing a processing procedure executed by the vehicle-mounted communication device according to the first embodiment.

FIG. 5 is a flowchart showing a processing procedure executed by the vehicle-mounted radio device according to the first embodiment.

FIG. 6 is a flowchart showing a processing procedure executed by a vehicle-mounted communication device according to a second embodiment.

FIG. 7 is a flowchart showing a processing procedure executed by a vehicle-mounted radio device according to the second embodiment.

FIG. 8 is a flowchart showing a processing procedure executed by a vehicle-mounted radio device according to a third embodiment.

### DETAILED DESCRIPTION OF PREFERRED EMBODIMENTS

### Description of Embodiments of Present Invention

First, aspects for carrying out the present invention will be described. Also, at least portions of the embodiments described below may be combined as desired.

(1) A tire air pressure monitoring system according to an aspect of the present invention is a tire air pressure monitoring system that includes an air pressure acquisition unit that acquires an air pressure of a tire of a vehicle, a vehicle-mounted radio device that wirelessly transmits a signal regarding the air pressure acquired by the air pressure acquisition unit, and a vehicle-mounted communication device that is provided at a different location from the vehicle-mounted radio device and receives the signal transmitted by the vehicle-mounted radio device, the tire air pressure monitoring system monitoring air pressure based on the signal received by the vehicle-mounted communication device, wherein the vehicle-mounted radio device includes: a calculation unit that calculates a temporal change amount of the air pressure acquired by the air pressure acquisition unit; and a transmission unit that transmits a signal that indicates the air pressure change amount calculated by the calculation unit.

In the invention of the present application, the vehicle-mounted radio device is arranged on the wheel of the tire for example, and wirelessly transmits a signal regarding the tire air pressure acquired by the air pressure acquisition unit. The vehicle-mounted communication device is arranged on the vehicle body for example, receives the signal transmitted by the vehicle-mounted radio device, and monitors the tire air pressure based on the received signal.

When a signal regarding a newly acquired air pressure is to be transmitted, the calculation unit of the vehicle-mounted radio device calculates a temporal change amount of the air pressure acquired by the air pressure acquisition unit, and the transmission unit transmits, to the vehicle-mounted communication device, a signal indicating the calculated air pressure change amount.

Accordingly, it is possible to reduce the information amount of the signals exchanged between the vehicle-mounted radio device and the vehicle-mounted communication device.

(2) A configuration is preferable in which the tire air pressure monitoring system includes a vehicle speed information acquisition unit that acquires speed information regarding the vehicle, in a case where a speed of the vehicle is low, the transmission unit transmits a signal indicating the air pressure acquired by the vehicle speed information acquisition unit, and in a case where the speed of the vehicle is high, the transmission unit transmits a signal indicating the change amount.

In the invention of the present application, in the case where the speed of the vehicle is low, the vehicle-mounted radio device transmits a signal that indicates the air pressure, and in the case where the speed of the vehicle is high, the vehicle-mounted radio device transmits a signal that indicates the change amount. If the speed of the vehicle is high and there is a high possibility of failure in signal transmission/reception, the probability of success in signal transmission/reception can be raised by reducing the information amount of the signal regarding the tire air pressure.

(3) A configuration is preferable in which in a case where the speed of the vehicle is high, the transmission unit transmits a signal with a higher degree of frequency than in a case where the speed of the vehicle is low.

In the invention of the present application, in the case where the speed of the vehicle is low, the vehicle-mounted radio device transmits the signal indicating the air pressure with a low degree of frequency, and in the case where the speed of the vehicle is high, the vehicle-mounted radio device transmits the signal indicating the change amount with a high degree of frequency. If the speed of the vehicle is high and there is a high possibility of failure in signal transmission/reception, the probability of success in signal transmission/reception can be raised by raising the transmission degree of frequency of the signal regarding the tire air pressure. Also, by reducing the information amount of the signals, it is possible to raise the probability of success in signal transmission/reception, and also prevent a processing delay and a decrease in the reliability of air pressure information.

(4) A configuration is preferable in which in a case where the change amount calculated by the calculation unit is less than a threshold value, the transmission unit transmits a predetermined signal having a smaller information amount than a signal that indicates the change amount.

In the invention of the present application, if the change amount between a previously acquired air pressure and a newly acquired air pressure is less than the threshold value, the vehicle-mounted radio device transmits, to the vehicle-mounted communication device, the predetermined signal that has a smaller information amount than a signal indicating the change amount. By reducing the information amount of the signals regarding tire air pressure that are exchanged between the vehicle-mounted radio device and the vehicle-mounted communication device, it is possible to raise the probability of success in signal transmission/reception, and also prevent a processing delay and a decrease in the reliability of air pressure information.

(5) A configuration is preferable in which the vehicle-mounted radio device includes a determination unit that determines whether or not the air pressure acquired by the air pressure acquisition unit is in a predetermined pressure range, and in a case where the air pressure is in the predetermined pressure range, the transmission unit transmits a predetermined signal having a smaller information amount than a signal that indicates the change amount.

In the invention of the present application, in the case where the acquired air pressure is in the predetermined pressure range, the vehicle-mounted radio device transmits, to the vehicle-mounted communication device, the predetermined signal that has an even smaller information amount than a signal that indicates the change amount. By reducing the information amount of the signals regarding tire air pressure that are exchanged between the vehicle-mounted radio device and the vehicle-mounted communication device, it is possible to raise the probability of success in signal transmission/reception, and also prevent a processing delay and a decrease in the reliability of air pressure information.

(6) A configuration is preferable in which the vehicle-mounted radio device includes a compression unit that compresses air pressure information, and the transmission unit transmits a signal that includes information compressed by the compression unit.

In the invention of the present application, the vehicle-mounted radio device compresses the information regarding the tire air pressure, and transmits a signal including the compressed information to the vehicle-mounted communication device. The vehicle-mounted communication device receives the signal transmitted by the vehicle-mounted radio device, and can acquire information regarding the tire air pressure by expanding the received signal.

By compressing the information regarding the tire air pressure, it is possible to reduce the information amount of the signals regarding tire air pressure that are exchanged between the vehicle-mounted radio device and the vehicle-mounted communication device.

(7) A vehicle-mounted radio device according to an aspect of the present invention is a vehicle-mounted radio device that includes an air pressure acquisition unit that acquires an air pressure of a tire of a vehicle, the vehicle-mounted radio device wirelessly transmitting a signal regarding the air pressure acquired by the air pressure acquisition unit, the vehicle-mounted radio device including: a calculation unit that calculates a temporal change amount of the air pressure acquired by the air pressure acquisition unit; and a transmission unit that transmits a signal that indicates the air pressure change amount calculated by the calculation unit.

In the invention of the present application, the vehicle-mounted radio device wirelessly transmits a signal regarding the air pressure acquired by the air pressure acquisition unit. When a signal regarding a newly acquired air pressure is to be transmitted, the calculation unit of the vehicle-mounted radio device calculates a temporal change amount of the air pressure acquired by the air pressure acquisition unit, and the transmission unit transmits, to the vehicle-mounted communication device, a signal indicating the calculated air pressure change amount.

Accordingly, it is possible to reduce the information amount of the signal transmitted to the vehicle-mounted communication device.

Specific examples of a tire air pressure monitoring system according to embodiments of the present invention will be described below with reference to the drawings. Note that the present invention is not limited to these examples, but rather is indicated by the scope of the claims, and all changes that come within the meaning and range of equivalence of the claims are intended to be embraced therein.

### First Embodiment

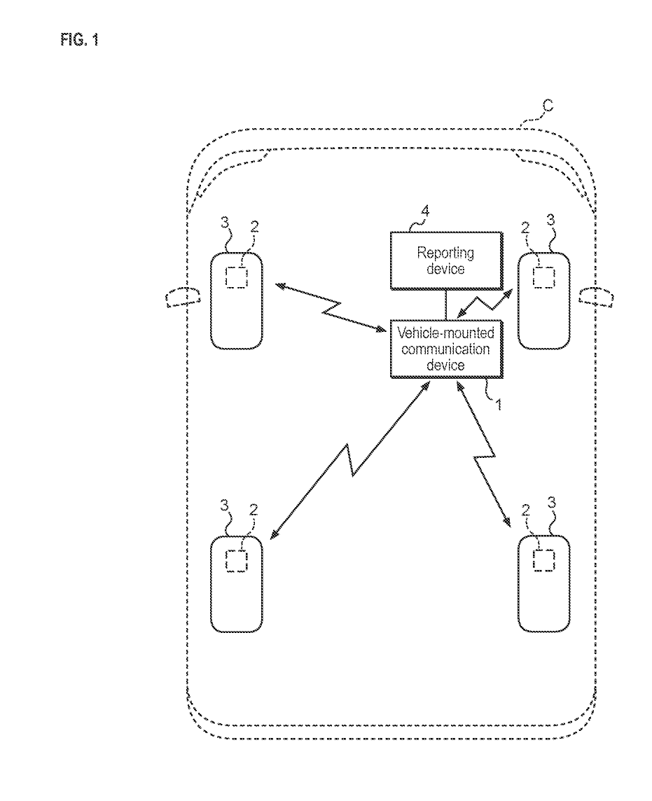

FIG. 1 is a schematic diagram showing one example of the configuration of a tire air pressure monitoring system according to a first embodiment of the present invention. The tire air pressure monitoring system of the first embodiment includes a vehicle-mounted communication device 1 provided at an appropriate location on a vehicle body, vehicle-mounted radio devices 2 that are respectively provided on the wheels of tires 3 mounted to a vehicle C, and a reporting device 4. In the tire air pressure monitoring system of the first embodiment, the vehicle-mounted communication device 1 acquires the air pressure of the tires 3 by performing wireless communication with the vehicle-mounted radio devices 2, and the reporting device 4 issues a report in accordance with the acquired air pressures. The vehicle-mounted communication device 1 uses LF-band (Low Frequency-band) radio waves to periodically transmit, to the vehicle-mounted radio devices 2, a request signal that requests a signal regarding the air pressure. In accordance with the request signal from the vehicle-mounted communication device 1, the vehicle-mounted radio devices 2 detect the air pressures of the tires 3 and use UHF-band (Ultra High Frequency-band) radio waves to transmit a signal regarding the acquired air pressure to the vehicle-mounted communication device 1. Note that the LF band and the UHF band are examples of the radio wave bands used when performing wireless communication, and the radio wave bands are not necessarily limited to these examples. The vehicle-mounted communication device 1 receives the signals transmitted by the vehicle-mounted radio devices 2, and acquires information indicating the air pressures of the tires 3 from the signals. The reporting device 4 is connected to the vehicle-mounted communication device 1 via a communication line, and the vehicle-mounted communication device 1 transmits the acquired air pressure information to the reporting device 4. The reporting device 4 receives the air pressure information transmitted by the vehicle-mounted communication device 1, and reports the air pressures. Also, the reporting device 4 issues a warning if the air pressure of a tire 3 is below a predetermined threshold value.

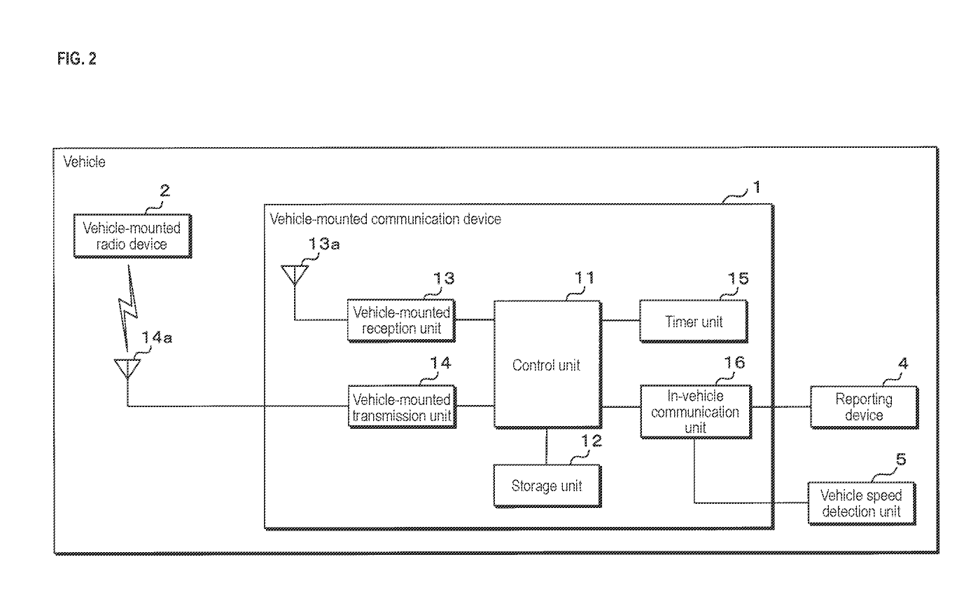

FIG. 2 is a block diagram showing one example of the configuration of the vehicle-mounted communication device 1. The vehicle-mounted communication device 1 includes a control unit 11 that controls the operations of the constituent units of the vehicle-mounted communication device 1. The control unit 11 is connected to a storage unit 12, a vehicle-mounted reception unit 13, a vehicle-mounted transmission unit 14, a timer unit 15, and an in-vehicle communication unit 16.

The control unit 11 is a microcontroller that has one or more CPUs (Central Processing Units) or a multi-core CPU, a ROM (Read Only Memory), a RAM (Random Access Memory), an input/output interface, and the like. The CPU of the control unit 11 is connected to the storage unit 12, the vehicle-mounted reception unit 13, the vehicle-mounted transmission unit 14, the timer unit 15, and the in-vehicle communication unit 16 via the input/output interface. By executing a control program stored in the storage unit 12, the control unit 11 controls the operations of the constituent units and executes communication processing and tire air pressure monitoring processing according to the present embodiment.

The storage unit 12 is a non-volatile memory such as an EEPROM (Electrically Erasable Programmable ROM) or a flash memory. The storage unit 12 stores a control program for the execution of communication processing and tire air pressure monitoring processing by the control unit 11 controlling the operations of the constituent units of the vehicle-mounted communication device 1.

An RF antenna 13a is connected to the vehicle-mounted reception unit 13. The vehicle-mounted reception unit 13 uses the RF antenna 13a to receive signals that are transmitted by the vehicle-mounted radio devices 2 using RF-band radio waves. The vehicle-mounted reception unit 13 is a circuit that demodulates the received signals and outputs the demodulated signals to the control unit 11. The 300 MHz to 3 GHz UHF band is used as the carrier wave, but the present invention is not limited to this frequency band.

The vehicle-mounted transmission unit 14 is a circuit that modulates signals output by the control unit 11 into LF-band signals, and transmits the modulated signals from an LF antenna 14a to the vehicle-mounted radio devices 2. The 30 kHz to 300 kHz LF band is used as the carrier wave, but the present invention is not limited to this frequency band.

The timer unit 15 is constituted by a timer, a real-time clock, or the like, and starts timing under control of the control unit 11 and gives a timing result to the control unit 11.

The in-vehicle communication unit 16 is a communication circuit that performs communication in accordance with a communication protocol such as CAN (Controller Area Network) or LIN (Local Interconnect Network), and is connected to the reporting device 4 and a vehicle speed detection unit 5. The in-vehicle communication unit 16 transmits information regarding the air pressures of the tires 3 to the reporting device 4 under control of the control unit 11.

The reporting device 4 is, for example, a display unit or an audio device provided with a speaker that uses images or audio to report information regarding the air pressures of the tires 3 that was transmitted by the in-vehicle communication unit 16, or a display unit provided in a gauge in the instrument panel. Examples of the display unit include a liquid crystal display, an organic EL display, and a head-up display. For example, the reporting device 4 displays the air pressures of the tires 3 mounted to the vehicle C.

The vehicle speed detection unit 5 includes, for example, a non-contact sensor provided with a magnetic pickup, Hall element, or the like that sends a signal that is proportional to the rotation speed of the axle provided in the vehicle C, and a counting circuit that counts the number of pulses from the non-contact sensor, and the vehicle speed detection unit 5 detects the speed of the vehicle C by counting the number of pulses. Note that a configuration is possible in which the vehicle speed detection unit 5 acquires acceleration information detected by acceleration sensors provided in the vehicle-mounted radio devices 2, and detects the speed of the vehicle C based on this acceleration information. The vehicle speed detection unit 5 outputs vehicle speed information, which indicates the speed of the vehicle C, to the in-vehicle communication unit 16, and the control unit 11 acquires the vehicle speed information with use of the vehicle speed detection unit 5.

The non-contact sensor is one example of the speed detection unit, and the present invention is not limited to this structure. For example, the vehicle speed detection unit 5 may be configured to detect the speed of the vehicle C based on position information regarding the vehicle C that is detected by GPS.

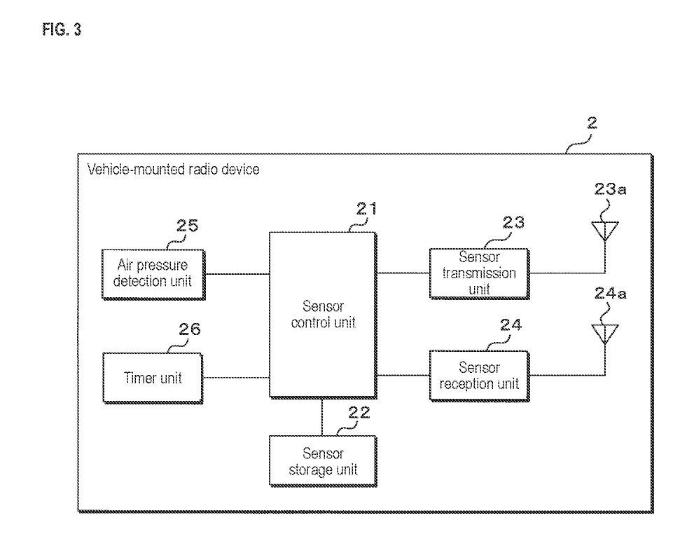

FIG. 3 is a block diagram showing one example of the configuration of the vehicle-mounted radio device 2. The vehicle-mounted radio device 2 includes a sensor control unit 21 that controls the operations of constituent units of the vehicle-mounted radio device 2. The sensor control unit 21 is connected to a sensor storage unit 22, a sensor transmission unit 23, a sensor reception unit 24, an air pressure detection unit 25, and a timer unit 26.

The sensor control unit 21 is a microcontroller that has one or more CPUs or a multi-core CPU, a ROM, a RAM, an input/output interface, and the like. The CPU of the sensor control unit 21 is connected to the sensor storage unit 22, the sensor transmission unit 23, the sensor reception unit 24, the air pressure detection unit 25, and the timer unit 26 via the input/output interface. The sensor control unit 21 reads out a control program stored in the sensor storage unit 22, and controls various units. The vehicle-mounted radio device 2 includes a battery (not shown), and operates using power from this battery.

The sensor storage unit 22 is a non-volatile memory. The sensor storage unit 22 stores a control program for the CPU of the sensor control unit 21 to perform processing related to the detection and transmission of the air pressure of a tire 3.

The air pressure detection unit 25 includes a diaphragm, for example, and detects the air pressure of the tire 3 based on a diaphragm deformation amount that varies according to the magnitude of pressure. This air pressure is an absolute pressure. This absolute pressure is a magnitude of pressure based on an absolute vacuum. Note that although it is described that the air pressure detected by the air pressure detection unit 25 is an absolute pressure in the present embodiment, a configuration is possible in which the air pressure detection unit 25 detects a gauge pressure or a differential pressure that indicates the magnitude of pressure relative to a predetermined reference pressure. This predetermined reference pressure is the median value, lower limit value, upper limit value, or the like of an air pressure range in which the tire 3 is in a state of not requiring inspection, for example.

The air pressure detection unit 25 outputs, to the sensor control unit 21, a signal indicating the detected air pressure of the tire 3. By executing the control program, the sensor control unit 21 acquires the air pressure of the tire 3 from the air pressure detection unit 25, generates a signal that indicates the air pressure and information such as a device ID unique to the vehicle-mounted radio device 2, and transmits this signal to the sensor transmission unit 23.

An RF antenna 23a is connected to the sensor transmission unit 23. The sensor transmission unit 23 modulates the signal generated by the sensor control unit 21 into a UHF-band signal, and transmits the modulated signal using the RF antenna 23a.

An LF antenna 24a is connected to the sensor reception unit 24. The sensor reception unit 24 uses the LF antenna 24a to receive a signal that is transmitted by the vehicle-mounted communication device 1 using LF-band radio waves, and outputs the received signal to the sensor control unit 21.

Next, processing procedures executed by the vehicle-mounted communication device 1 and the vehicle-mounted radio devices 2 in relation to signal transmission and reception will be described in order. It is assumed that the vehicle-mounted communication device 1 transmits a request signal to the vehicle-mounted radio devices 2 with a predetermined transmission degree of frequency, and the vehicle-mounted radio devices 2 transmit signals regarding the air pressures of the tires 3 to the vehicle-mounted communication device 1 in accordance with the request signal.

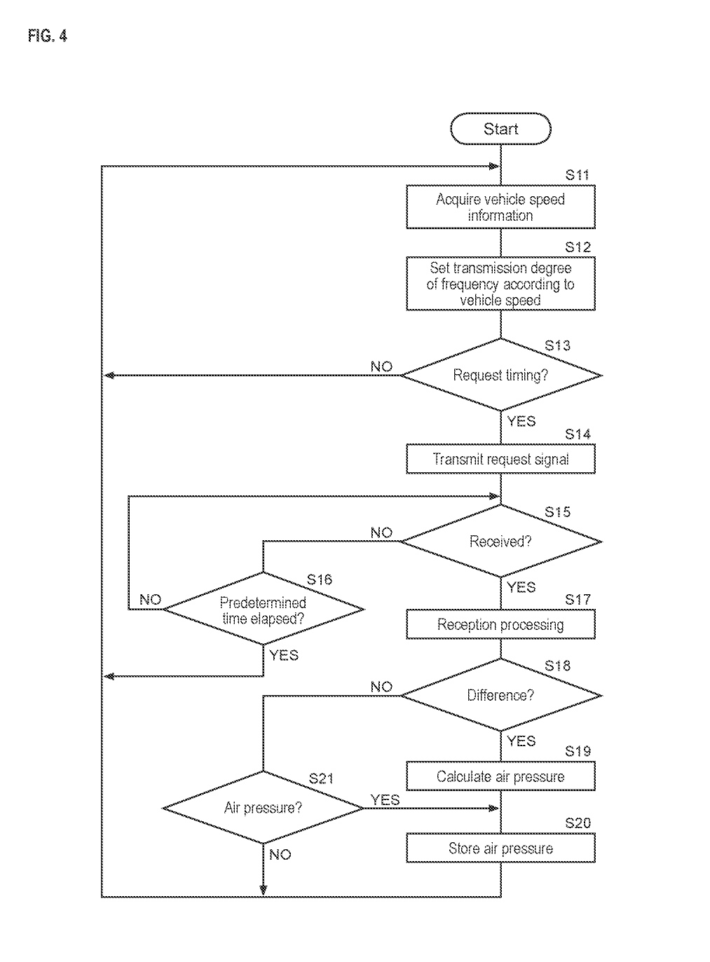

FIG. 4 is a flowchart showing a processing procedure executed by the vehicle-mounted communication device 1 according to the first embodiment. The control unit 11 of the vehicle-mounted communication device 1 acquires vehicle speed information from the vehicle speed detection unit 5 (step S11), and sets a request signal transmission degree of frequency in accordance with the vehicle speed (step S12). The request signal is a signal by which the vehicle-mounted communication device 1 requests the vehicle-mounted radio devices 2 to transmit signals regarding the air pressures of the tires 3. If the vehicle C is traveling at a low speed, the request signal transmission degree of frequency is once per 60 seconds for example, and the vehicle-mounted communication device 1 raises the transmission degree of frequency as the vehicle speed of the vehicle C increases.

Next, the control unit 11 references the timing result of the timer unit 15 and determines whether or not the timing for transmitting the request signal has been reached (step S13). If it is determined that the timing for transmitting the request signal has not been reached (step S13: NO), the control unit 11 returns the processing to step S11.

If it is determined that the timing for transmitting the request signal has been reached (step S13: YES), the control unit 11 causes the vehicle-mounted transmission unit 14 to transmit, to the vehicle-mounted radio devices 2, a request signal that includes the vehicle speed information acquired in step S11 (step S14). As will be described later, when a vehicle-mounted radio device 2 receives the request signal, it detects the air pressure of the tire 3 and transmits, to the vehicle-mounted communication device 1, a signal regarding the detected air pressure of the tire 3.

The control unit 11 that transmitted the request signal in the processing of step S14 then determines whether or not a signal has been received from a vehicle-mounted radio device 2 (step S15). If it is determined that a signal has not been received from a vehicle-mounted radio device 2 (step S15: NO), the control unit 11 determines whether or not a predetermined time has elapsed since transmission of the request signal (step S16). The amount of time elapsed since transmission of the request signal is timed by the timer unit 15 in accordance with an instruction from the control unit 11. If it is determined that the predetermined time has not elapsed since transmission of the request signal (step S16: NO), the control unit 11 returns the processing to step S15 and waits in a state of standby for reception of a signal from a vehicle-mounted radio device 2. If it is determined that the predetermined time has elapsed since transmission of the request signal (step S16: YES), the control unit 11 returns the processing to step S11.

[If a signal transmitted by a vehicle-mounted radio device 2 is received (step S15: YES), the control unit 11 performs reception processing (step S17). In reception processing, signal demodulation, processing for extracting information from the demodulated signal, and the like is performed. Also, if the information regarding the air pressure is compressed, the control unit 11 expands the information to obtain the information regarding the air pressure.

Next, the control unit 11 determines whether or not the received signal indicates a difference from the previously detected air pressure (step S18). The signal transmitted by the vehicle-mounted radio device 2 includes identification information for identifying whether the information in the signal is an absolute value of the air pressure of the tire 3 or a difference, and therefore by referencing this identification information, the control unit 11 can determine whether or not the received signal indicates a difference.

If it is determined that the received signal indicates an air pressure difference (step S18: YES), the control unit 11 reads out the previously detected or calculated air pressure from the storage unit 12 and calculates the absolute value of the currently detected air pressure based on the difference between the air pressure that was read out and the difference indicated by the received signal (step S19). The control unit 11 then stores the absolute value of the currently detected air pressure in the storage unit 12 (step S20), and then returns the processing to step S11.

If it is determined that the received signal does not indicate an air pressure difference (step S18: NO), the control unit 11 determines whether the received signal indicates an absolute value of the air pressure (step S21). If it is determined that the received signal does not indicate an absolute value of the air pressure (step S21: NO), the control unit 11 returns the processing to step S11. If it is determined that the received signal indicates an absolute value of the air pressure (step S21: YES), the control unit 11 stores the absolute value of the air pressure indicated by the received signal in the storage unit 12 (step S20), and then returns the processing to step S11.

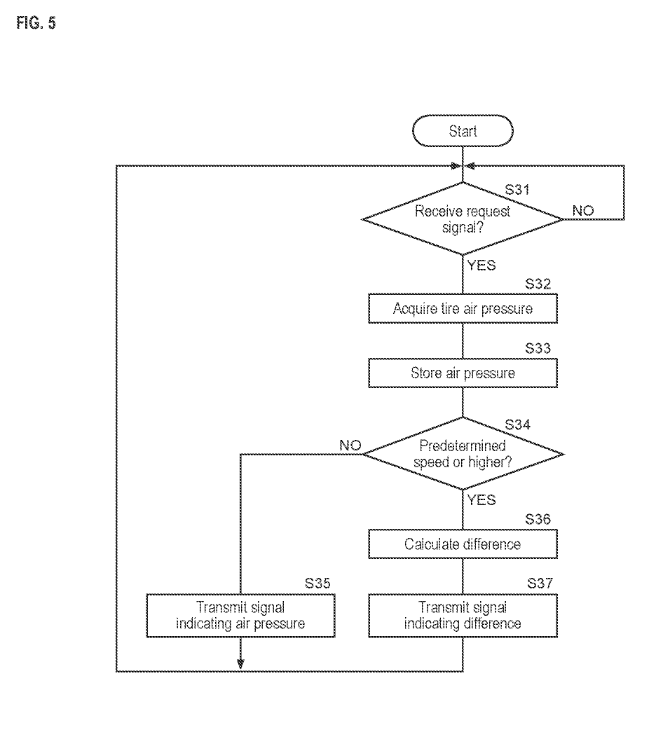

FIG. 5 is a flowchart showing a processing procedure executed by the vehicle-mounted radio device 2 according to the first embodiment. The sensor control unit 21 of the vehicle-mounted radio device 2 determines whether or not a request signal transmitted by the vehicle-mounted communication device 1 has been received (step S31). If it is determined that a request signal has not been received (step S31: NO), the sensor control unit 21 returns the processing to step S31 and waits until a request signal is received.

If it is determined that a request signal has been received (step S31: YES), the sensor control unit 21 acquires the air pressure of the tire 3 that was detected by the air pressure detection unit 25 (step S32), and stores the acquired air pressure in the sensor storage unit 22 (step S33).

Next, the sensor control unit 21 determines whether or not the vehicle speed is greater than or equal to a predetermined speed based on the vehicle speed information included in the request information (step S34). If it is determined that the vehicle speed is less than the predetermined speed (step S34: NO), the sensor control unit 21 causes the sensor transmission unit 23 to transmit, to the vehicle-mounted communication device 1, a signal indicating the absolute value of the detected air pressure (step S35), and then returns the processing to step S31. More specifically, the sensor control unit 21 generates a signal that includes information indicating the absolute value of the air pressure and identification information indicating that that information is information indicating the absolute value of the air pressure, and transmits the generated signal to the vehicle-mounted transmission unit 14. Also, the sensor control unit 21 may compress the information indicating the absolute value of the air pressure and the identification information, generate a signal that includes the compressed information, and transmit this signal to the vehicle-mounted transmission unit 14.

If it is determined in step S34 that the vehicle speed is greater than or equal to the predetermined speed (step S34: YES), the sensor control unit 21 reads out the previously detected or calculated air pressure from the sensor storage unit 22, and calculates the difference between the air pressure that was read out and the currently detected air pressure (step S36). The sensor control unit 21 then causes the sensor transmission unit 23 to transmit, to the vehicle-mounted communication device 1, a signal indicating the calculated difference (step S37), and then returns the processing to step S31. More specifically, the sensor control unit 21 generates a signal that includes information indicating the air pressure difference and identification information indicating that that information is information indicating the difference from the previously detected air pressure, and transmits the generated signal to the vehicle-mounted transmission unit 14. Also, the sensor control unit 21 may compress the information indicating the air pressure difference and the identification information, generate a signal that includes the compressed information, and transmit this signal to the vehicle-mounted transmission unit 14.

According to the tire air pressure monitoring system of the first embodiment having the above configuration, if the vehicle speed of the vehicle C is high and there is a high possibility of failure in signal transmission/reception, it is possible to raise the probability of success in signal transmission/reception by raising the transmission degree of frequency of the signal regarding the air pressure of the tire 3. Also, if the vehicle speed of the vehicle C is high, by transmitting and receiving a signal that indicates the difference from the previously detected air pressure of the tire 3, it is possible to reduce the information amount of the signals transmitted and received by the vehicle-mounted radio device 2 and the vehicle-mounted communication device 1, thus making it possible to raise the probability of success in signal transmission/reception and also prevent a processing delay and a decrease in the reliability of air pressure information.

Also, by compressing the information regarding the air pressure of the tire 3, it is possible to further reduce the information amount of the signals regarding the air pressure of the tire 3 that are exchanged between the vehicle-mounted radio device 2 and the vehicle-mounted communication device 1.

Note that in the example described in the first embodiment, the determination of whether the absolute value of the air pressure of the tire 3 is to be transmitted or the difference is to be transmitted is made by the vehicle-mounted radio device 2 based on vehicle speed information transmitted by the vehicle-mounted communication device 1, but a configuration is possible in which this determination is made by the vehicle-mounted communication device 1. Specifically, the vehicle-mounted communication device 1 determines whether or not an air pressure difference is to be requested, based on the acquired vehicle speed information. Also, the vehicle-mounted communication device 1 may acquire acceleration information detected by an acceleration sensor provided in the vehicle-mounted radio device 2, and determine whether or not an air pressure difference is to be requested based on the acquired acceleration information. If it is determined that the absolute value is to be requested, the vehicle-mounted communication device 1 transmits a first request signal that requests transmission of a signal indicating the air pressure of the tire 3, and if it is determined that the difference is to be requested, the vehicle-mounted communication device 1 transmits a second request signal that requests transmission of a signal that indicates the difference of the air pressure of the tire 3. If the first request signal is received, the vehicle-mounted radio device 2 transmits a signal indicating the air pressure of the tire 3 to the vehicle-mounted communication device 1, and if the second request signal is received, the vehicle-mounted radio device 2 transmits a signal indicating the difference to the vehicle-mounted communication device 1.

Also, an example was described in which the determination of whether the absolute value of the air pressure of the tire 3 is to be transmitted or the difference is to be transmitted is made by the vehicle-mounted radio device 2 based on vehicle speed information transmitted by the vehicle-mounted communication device 1, but a configuration is possible in which the vehicle-mounted radio device 2 determines whether the absolute value of the air pressure of the tire 3 is to be transmitted or the difference is to be transmitted based on acceleration information detected by the acceleration sensor provided in the vehicle-mounted radio device 2 or based on acceleration information transmitted by the vehicle-mounted communication device 1. Note that the vehicle-mounted communication device 1 can acquire acceleration information from an acceleration sensor (not shown) installed in the vehicle C and transmit the acquired acceleration information to the vehicle-mounted radio device 2.

Also, in the example described in the first embodiment, the vehicle-mounted communication device 1 manages the transmission cycle and transmission timing of the signal regarding the air pressure of the tire 3, but a configuration is possible in which the vehicle-mounted radio device 2 manages the transmission cycle and the transmission timing of the signal. Specifically, it is sufficient that the vehicle-mounted communication device 1 transmits vehicle speed information to the vehicle-mounted radio device 2, and the vehicle-mounted radio device 2 determines the transmission degree of frequency based on the vehicle speed information. Also, it is sufficient that the sensor control unit 21 determines the transmission timing with use of the timer unit 26.

### Second Embodiment

A tire air pressure monitoring system according to a second embodiment has a configuration similar to that of the first embodiment, and only the processing procedures executed by the vehicle-mounted radio device 2 and the vehicle-mounted communication device 1 are different from the first embodiment, and therefore the following description will focus mainly on these differences. Other configurations, actions, and effects are similar to those of the first embodiment, and therefore corresponding portions will be denoted by the same reference signs, and detailed descriptions will not be given for them.

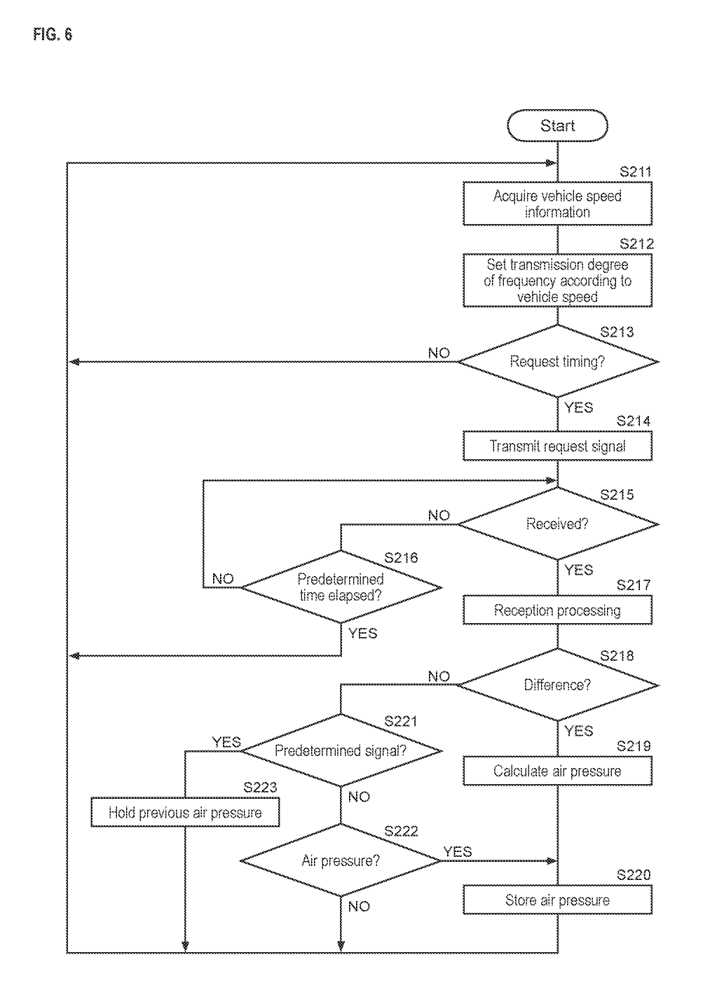

FIG. 6 is a flowchart showing a processing procedure executed by the vehicle-mounted communication device 1 according to the second embodiment. In steps S211 to S220, the vehicle-mounted communication device 1 of the second embodiment executes processing similar to steps S11 to S20 in the first embodiment. In step S218, the control unit 11 determines whether or not the received signal indicates a difference from the previously detected air pressure (step S218). If it is determined that the received signal does not indicate an air pressure difference (step S218: NO), the control unit 11 determines whether the received signal is a predetermined signal (step S221). This predetermined signal is a signal transmitted by the vehicle-mounted radio device 2 if the difference from the previously detected air pressure is less than a threshold value. The information amount of the predetermined signal is smaller than the information amount of the signal indicating an air pressure difference.

If it is determined that the received signal is the predetermined signal (step S221: YES), the control unit 11 stores the value of the air pressure stored by the storage unit 12 in the storage unit 12 as the currently detected air pressure (step S223), and then returns the processing to step S211.

If it is determined that the received signal is not the predetermined signal (step S221: NO), the control unit 11 determines whether or not the received signal indicates an absolute value of the air pressure (step S222). If it is determined that the received signal does not indicate an absolute value of the air pressure (step S222: NO), the control unit 11 returns the processing to step S211. If it is determined that the received signal indicates an absolute value of the air pressure (step S222: YES), the control unit 11 stores the absolute value of the air pressure indicated by the received signal in the storage unit 12 (step S220), and then returns the processing to step S211.

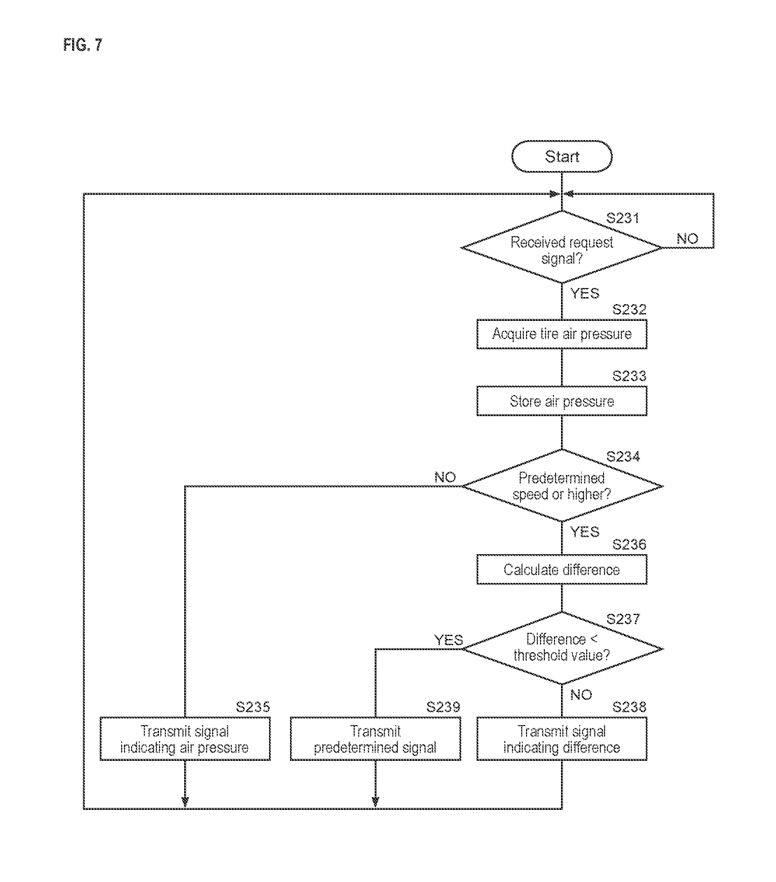

FIG. 7 is a flowchart showing a processing procedure executed by the vehicle-mounted radio device 2 according to the second embodiment. In steps S231 to S235, the sensor control unit 21 of the second embodiment executes processing similar to steps S31 to S35 in the first embodiment. The sensor control unit 21 that calculated the air pressure difference in step S236 then determines whether or not the calculated difference is less than a threshold value (step S237). The threshold value is not limited to a specific value, but rather need only be appropriately determined according to the precision required for the air pressure monitored by the vehicle-mounted communication device 1.

If it is determined that the difference calculated in step S236 is greater than or equal to the threshold value (step S237: NO), the sensor control unit 21 causes the sensor transmission unit 23 to transmit, to the vehicle-mounted communication device 1, a signal indicating the calculated difference (step S238), and then returns the processing to step S231. If it is determined that the calculated difference is less than the threshold value (step S237: YES), the sensor control unit 21 causes the sensor transmission unit 23 to transmit the predetermined signal to the vehicle-mounted communication device 1 (step S239), and then returns the processing to step S231.

According to the tire air pressure monitoring system of the second embodiment having the above configuration, if the difference between a previous air pressure stored by the sensor storage unit 12 and a newly detected air pressure is less than the threshold value, the vehicle-mounted radio device 2 transmits, to the vehicle-mounted communication device 1, the predetermined signal that has an even smaller information amount than a signal indicating the difference. For this reason, it is possible to further reduce the information amount of the signals regarding the air pressure of the tire 3 that are exchanged between the vehicle-mounted radio device 2 and the vehicle-mounted communication device 1. Accordingly, it is possible to raise the probability of success in the transmission and reception of signals regarding the air pressure of the tire 3, and also prevent a processing delay and a decrease in the reliability of air pressure information.

### Third Embodiment

A tire air pressure monitoring system according to a third embodiment has a configuration similar to that of the first embodiment, and only the processing procedures executed by the vehicle-mounted radio device 2 and the vehicle-mounted communication device 1 are different from the first embodiment, and therefore the following description will focus mainly on these differences. Other configurations, actions, and effects are similar to those of the first embodiment, and therefore corresponding portions will be denoted by the same reference signs, and detailed descriptions will not be given for them.

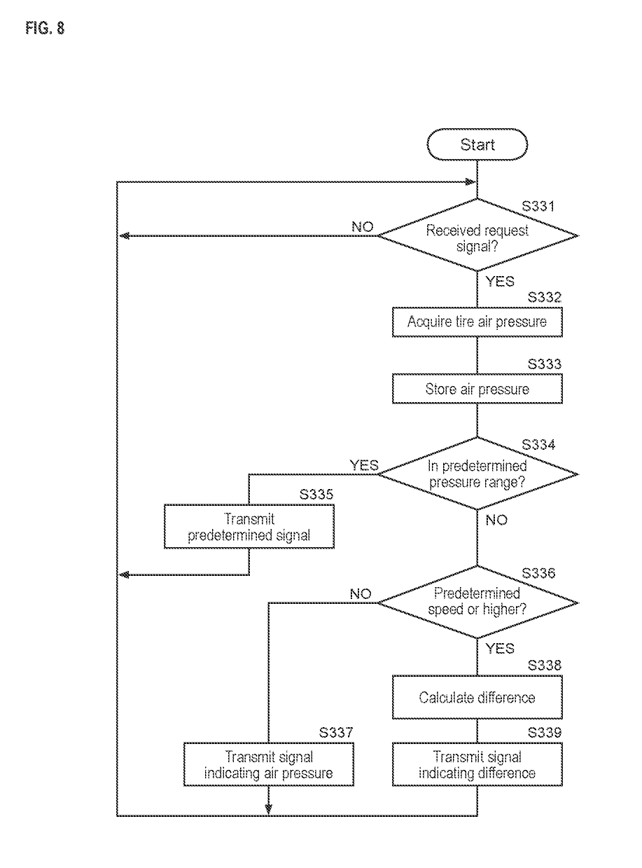

FIG. 8 is a flowchart showing a processing procedure executed by the vehicle-mounted radio device 2 according to the third embodiment. In steps S331 to S333, the sensor control unit 21 of the third embodiment executes processing similar to steps S31 to S33 in the first embodiment. After finishing the processing of the step S333, the sensor control unit 21 determines whether or not the air pressure of the tire 3 acquired in step S332 is in a predetermined pressure range (step S334). The predetermined pressure range is a range of appropriate air pressures for the tire 3, and is a range of air pressures at which a special warning is not necessary. If it is determined that the air pressure detected in step S332 is in the predetermined pressure range (step S334: YES), the sensor control unit 21 transmits a predetermined signal to the vehicle-mounted communication device 1 (step S335), and then returns the processing to step S331. The information amount of this predetermined signal is smaller than the information amount of a signal indicating an air pressure difference. If it is determined that the air pressure detected in step S332 is outside of the predetermined pressure range (step S334: NO), the sensor control unit 21 executes processing similar to steps S34 to S37 in the first embodiment in steps S336 to S339.

The content of processing executed by the vehicle-mounted communication device 1 is similar to that in the second embodiment, and it is sufficient that if the predetermined signal is received from the vehicle-mounted radio device 2, the control unit 11 stores the value of the air pressure stored by the storage unit 12 in the storage unit 12 as the currently detected air pressure. Note that if a signal indicating a difference is received after receiving the predetermined signal, there are cases where a value different from the actual air pressure is calculated, but this is not particularly a problem because when the vehicle speed of the vehicle C decreases to a low speed, the control unit 11 acquires the correct absolute value of the air pressure and stores it in the storage unit 12. Also, if the air pressure is outside of the predetermined pressure range, and the air pressure of the tire 3 needs to be monitored continuously, the predetermined signal will not be transmitted, and therefore such a problem will not occur.

According to the tire air pressure monitoring system of the third embodiment having the above configuration, if the detected air pressure is in the predetermined pressure range, the vehicle-mounted radio device 2 transmits, to the vehicle-mounted communication device 1, the predetermined signal that has an even smaller information amount than a signal that indicates a difference. For this reason, it is possible to further reduce the information amount of the signals regarding the air pressure of the tire 3 that are exchanged between the vehicle-mounted radio device 2 and the vehicle-mounted communication device 1. Accordingly, it is possible to raise the probability of success in the transmission and reception of signals regarding the air pressure of the tire 3, and also prevent a processing delay and a decrease in the reliability of air pressure information.

Note that although the third embodiment is described as a variation of the first embodiment, a tire air pressure monitoring system may be configured by combining the second and third embodiments.

1. A tire air pressure monitoring system comprising an air pressure acquisition unit that acquires an air pressure of a tire of a vehicle, a vehicle-mounted radio device that wirelessly transmits a signal regarding the air pressure acquired by the air pressure acquisition unit, and a vehicle-mounted communication device that is provided at a different location from the vehicle-mounted radio device and receives the signal transmitted by the vehicle-mounted radio device, the tire air pressure monitoring system monitoring air pressure based on the signal received by the vehicle-mounted communication device,
wherein the vehicle-mounted radio device comprises:
a calculation unit that calculates a temporal change amount of the air pressure acquired by the air pressure acquisition unit; and
a transmission unit that transmits a signal that indicates the air pressure change amount calculated by the calculation unit.

2. The tire air pressure monitoring system according to claim 1,
comprising a vehicle speed information acquisition unit that acquires speed information regarding the vehicle,
wherein in a case where a speed of the vehicle is low, the transmission unit transmits a signal indicating the air pressure acquired by the air pressure acquisition unit, and in a case where the speed of the vehicle is high, the transmission unit transmits a signal indicating the change amount.

3. The tire air pressure monitoring system according to claim 2, wherein in a case where the speed of the vehicle is high, the transmission unit transmits a signal with a higher degree of frequency than in a case where the speed of the vehicle is low.

4. The tire air pressure monitoring system according to claim 1, wherein in a case where the change amount calculated by the calculation unit is less than a threshold value, the transmission unit transmits a predetermined signal having a smaller information amount than a signal that indicates the change amount.

5. The tire air pressure monitoring system according to claim 1,
wherein the vehicle-mounted radio device comprises a determination unit that determines whether or not the air pressure acquired by the air pressure acquisition unit is in a predetermined pressure range, and
in a case where the air pressure is in the predetermined pressure range, the transmission unit transmits a predetermined signal having a smaller information amount than a signal that indicates the change amount.

6. The tire air pressure monitoring system according to claim 1,
wherein the vehicle-mounted radio device comprises a compression unit that compresses air pressure information, and
the transmission unit transmits a signal that includes information compressed by the compression unit.

7. A vehicle-mounted radio device comprising an air pressure acquisition unit that acquires an air pressure of a tire of a vehicle, the vehicle-mounted radio device wirelessly transmitting a signal regarding the air pressure acquired by the air pressure acquisition unit, the vehicle-mounted radio device comprising:
a calculation unit that calculates a temporal change amount of the air pressure acquired by the air pressure acquisition unit; and
a transmission unit that transmits a signal that indicates the air pressure change amount calculated by the calculation unit.

8. The tire air pressure monitoring system according to claim 2, wherein in a case where the change amount calculated by the calculation unit is less than a threshold value, the transmission unit transmits a predetermined signal having a smaller information amount than a signal that indicates the change amount.

9. The tire air pressure monitoring system according to claim 3, wherein in a case where the change amount calculated by the calculation unit is less than a threshold value, the transmission unit transmits a predetermined signal having a smaller information amount than a signal that indicates the change amount.

10. The tire air pressure monitoring system according to claim 2, wherein the vehicle-mounted radio device comprises a determination unit that determines whether or not the air pressure acquired by the air pressure acquisition unit is in a predetermined pressure range, and in a case where the air pressure is in the predetermined pressure range, the transmission unit transmits a predetermined signal having a smaller information amount than a signal that indicates the change amount.

11. The tire air pressure monitoring system according to claim 3, wherein the vehicle-mounted radio device comprises a determination unit that determines whether or not the air pressure acquired by the air pressure acquisition unit is in a predetermined pressure range, and in a case where the air pressure is in the predetermined pressure range, the transmission unit transmits a predetermined signal having a smaller information amount than a signal that indicates the change amount.

12. The tire air pressure monitoring system according to claim 2, wherein the vehicle-mounted radio device comprises a compression unit that compresses air pressure information, and the transmission unit transmits a signal that includes information compressed by the compression unit.

13. The tire air pressure monitoring system according to claim 3, wherein the vehicle-mounted radio device comprises a compression unit that compresses air pressure information, and the transmission unit transmits a signal that includes information compressed by the compression unit.

14. The tire air pressure monitoring system according to claim 4, wherein the vehicle-mounted radio device comprises a compression unit that compresses air pressure information, and the transmission unit transmits a signal that includes information compressed by the compression unit.

15. The tire air pressure monitoring system according to claim 5, wherein the vehicle-mounted radio device comprises a compression unit that compresses air pressure information, and the transmission unit transmits a signal that includes information compressed by the compression unit.
